(19) United States
(12) Patent Application Publication
(10) Pub. No.: US 2007/0292742 A1
(43) Pub. Date: Dec. 20, 2007

(54) Fuel Cell System

(76) Inventors: Sarah Caroline Ball, Oxon (GB); David Thompsett, Reading (GB)

Correspondence Address: RATNERPRESTIA, P O BOX 980, VALLEY FORGE, PA, 19482-0980, US

(21) Appl. No.: 11/597,653

(22) PCT Filed: May 19, 2005
(86) PCT No.: PCT/GB05/01935

§ 371 Date: Jun. 27, 2007

(30) Foreign Application Priority Data
May 26, 2004 (GB) 0411735.4

(51) Int. Cl. H01M 8/24; H01M 4/00; H01M 4/90; H01M 4/92

(52) U.S. Cl. 429/40; 429/12

(57) ABSTRACT

A fuel cell system includes one or more fuel cell stacks. The fuel cell stack(s) include a first group of membrane electrode assemblies and a second group of membrane electrode assemblies, wherein the first and second groups of membrane electrode assemblies are connected in series such that a feed stream supplied to the first group is subsequently supplied to the second group. The anodes of the membrane electrode assemblies of the first group include an electrocatalyst for the electrochemical oxidation of carbon monoxide and can reduce the concentration of carbon monoxide in a feed stream comprising carbon monoxide before it is supplied to the membrane electrode assemblies of the second group.

The present invention relates to a fuel cell system made up of one or more stacks of membrane electrode assemblies and, in particular, to a fuel cell system that can be fuelled by reformate gas comprising carbon monoxide.

A fuel cell is an electrochemical cell comprising two electrodes separated by an electrolyte. A fuel, e.g. hydrogen or methanol, is supplied to the anode and an oxidant, e.g. oxygen or air, is supplied to the cathode. Electrochemical reactions occur at the electrodes, and the chemical energy of the fuel and the oxidant is converted to electrical energy and heat. Fuel cells are a clean and efficient power source, and may replace traditional power sources such as the internal combustion engine in both stationary and automotive power applications.

In a polymer electrolyte membrane (PEM) fuel cell, the electrolyte is a solid polymer membrane which is electronically insulating but ionically-conducting. Proton-conducting membranes such as those based on perfluorosulphonic acid materials are typically used, and protons, produced at the anode, are transported across the membrane to the cathode, where they combine with oxygen to create water.

The principle component of a polymer electrolyte fuel cell is known as a membrane electrode assembly (MEA) and is essentially composed of five layers. The central layer is the polymer membrane. On either side of the membrane there is an electrocatalyst layer, typically comprising a platinum-based electrocatalyst. An electrocatalyst is a catalyst that promotes the rate of an electrochemical reaction. Finally, adjacent to each electrocatalyst layer there is a gas diffusion substrate. The gas diffusion substrate must allow the reactants to reach the electrocatalyst layer and must conduct the electric current that is generated by the electrochemical reactions. Therefore the substrate must be porous and electrically conducting.

Typically tens or hundreds of MEAs are required to provide enough power for most applications, so multiple MEAs are assembled to make up a fuel cell stack. Field flow plates are used to separate the MEAs. The plates perform several functions: supplying the reactants to the MEAs, removing products, providing electrical connections and providing physical support. The field flow plates and MEAs in the stack are compressed together at pressures typically from 50 to 200 psi absolute, using for example a bladder or piston system or a series of bolts located in stack end plates. Typically, one of the stack end plates also contains the necessary ports to provide access and removal from the stack of the reactants, products and any associated humidification water. A fuel cell system may comprise several stacks which are typically connected in parallel (fuel is provided separately to each stack).

In many practical fuel cell systems hydrogen fuel is produced by converting a hydrocarbon fuel (such as methane or gasoline) or an oxygenated hydrocarbon fuel (such as methanol) to a gas stream known as reformate in a process known as reforming. The reformate gas contains hydrogen, about 20-25% carbon dioxide and small amounts of carbon monoxide (typically at levels of around 1%). The reformate gas may contain diluents such as nitrogen, or may contain other contaminants. For fuel cell operating temperatures below 200° C. and especially for PEM fuel cells operating at temperatures of around 100° C., carbon monoxide, even at levels of 1-10 ppm, is a severe poison for the platinum electrocatalyst in the anodes of the MEAs. This leads to a significant reduction in fuel cell performance (i.e. the cell voltage at a given current density is reduced).

To alleviate anode carbon monoxide poisoning, most reformer systems include an additional catalytic reactor known as a preferential or selective oxidation reactor. Air or oxygen is injected into the reformate gas stream, which is then passed over a selective oxidation catalyst which oxidises the carbon monoxide to carbon dioxide. This can reduce the levels of CO from about 1% down to below 100 ppm, but even at these levels the anode electrocatalyst is poisoned.

WO 00/35037 discloses carbon monoxide tolerant anodes comprising a first electrocatalyst of formula Pt—Y, wherein Y is a bronze forming element, and a second electrocatalyst of formula Pt-M, wherein M is a metal alloyed with the platinum, wherein the first and second electrocatalysts are in ionic contact. Membrane electrode assemblies comprising the anodes exhibit good performance even at levels of 100 ppm CO.

The present inventors have sought to provide a fuel cell system that is tolerant to even higher levels of carbon monoxide, such that it is possible to simplify the CO clean-up apparatus in the reformer system.

Accordingly, the present invention provides a fuel cell system comprising one or more fuel cell stacks,

wherein the fuel cell stack(s) comprise a first group of membrane electrode assemblies and a second group of membrane electrode assemblies,

wherein the first and second groups of membrane electrode assemblies are connected in series such that a feed stream supplied to the first group is subsequently supplied to the second group, and

wherein the anodes of the membrane electrode assemblies of the first group comprise an electrocatalyst for the electrochemical oxidation of carbon monoxide and are better at reducing the concentration of carbon monoxide in a feed stream comprising carbon monoxide than the membrane electrode assemblies of the second group.

The first group of membrane electrode assemblies operates as a carbon monoxide clean-up reactor, providing reformate with significantly reduced carbon monoxide levels to the second group of membrane electrode assemblies. The second group of membrane electrode assemblies can have reduced tolerance to carbon monoxide, and can be optimised for hydrogen oxidation. The fuel cell system can tolerate higher levels of carbon monoxide (up to 20,000 ppm) and the CO clean-up apparatus in the reformer system can be simplified.

In a first embodiment of the invention, the fuel cell system comprises only one fuel cell stack, wherein some of the membrane electrode assemblies in the fuel cell stack provide the first group of membrane electrode assemblies, and some of the membrane electrode assemblies in the fuel cell stack provide the second group of membrane electrode assemblies.

In a second embodiment of the invention, the fuel cell system comprises a first fuel cell stack and a second fuel cell stack, wherein the first and second fuel cell stacks are connected in series such that a feed stream supplied to the first fuel cell stack is subsequently supplied to the second fuel cell stack, and wherein some or all of the membrane electrode assemblies in the first fuel cell stack provide the first group of membrane electrode assemblies, and some or all of the membrane electrode assemblies in the second fuel cell stack provide the second group of membrane electrode assemblies. The fuel cell system may further comprise further fuel cell stacks, which are suitably connected downstream of the first fuel cell stack.

Preferably all of the membrane electrode assemblies in the first fuel cell stack provide the first group of membrane electrode assemblies, and all of the membrane electrode assemblies in the second fuel cell stack provide the second group of membrane electrode assemblies. This is advantageous because the first stack is used for CO clean-up and can be optimised for CO clean-up. The second stack is not used for CO clean-up and can be optimised for hydrogen oxidation. For example, the first stack and the second stack can be operated at different current-potential conditions allowing optimisation of CO clean-up in the first stack and optimisation of hydrogen oxidation in the second stack.

In all embodiments of the invention, the ratio of membrane electrode assemblies in the first group to membrane electrode assemblies in the second group is suitably between 1:1 and 1:100, preferably between 1:3 and 1:50.

The electrocatalyst for the electrochemical oxidation of carbon monoxide in the anodes of the membrane electrode assemblies of the first group catalyses the following reaction:
CO+H₂O→CO₂+2H⁺+2e⁻
Suitably the electrocatalyst is optimised so that it is not effective at catalysing the electrochemical oxidation of hydrogen so that hydrogen can pass through the first group of membrane electrode assemblies and be consumed by the second group of membrane electrode assemblies.

Preferably, the electrocatalyst for the electrochemical oxidation of carbon monoxide is of formula Pt—Y or Pt—Y—X, wherein Y is a bronze-forming element or oxide thereof or Y is Sn, and X is one or more metals alloyed with the platinum. Component Y may be alloyed with the Pt or the Pt—X alloy, or may be unalloyed but in physical contact with the alloy. A “bronze” material is defined by Wold and Dwight in ‘Solid State Chemistry—Synthesis, Structure and Properties of Selected Oxides and Sulfides’ as “an oxide with intense colour (or black), having a metallic lustre and showing either semi-conducting or metallic behaviour. A principle characteristic of bronzes is their range of composition, which results in the transition metal exhibiting a variable formal valence”. Y is suitably selected from the group consisting of Sn, Ti, V, Nb, Ta, Mo, W, Re or an oxide thereof; preferably from Sn, Ti, V, Ta, Mo, W or an oxide thereof; most preferably from Sn, Mo or W or an oxide thereof. X is suitably one or more metals selected from the group consisting of Ru, Rh, Ti, Cr, Mn, Fe, Co, Ni, Cu, V, Ga, Zr and Hf and is preferably one or more of Ru, Mn, Ti, Co, Ni and Rh. A preferred electrocatalyst for the electrochemical oxidation of carbon monoxide is Pt—Mo.

In a particular embodiment of the invention, the anodes of the membrane electrode assemblies of the first group further comprise an electrocatalyst for the electrochemical oxidation of hydrogen and the electrocatalyst is preferably of formula Pt-M, wherein M is a metal alloyed with the platinum and is selected from the group consisting of Ru, Rh, Ti, Cr, Mn, Fe, Co, Ni, Cu, V, Ga, Zr, Hf and Sn.

In an alternative embodiment of the invention, the anodes of the membrane electrode assemblies of the first group do not contain any electrocatalysts other than the electrocatalyst for the oxidation of carbon monoxide. This is preferred, because the membrane electrode assemblies can be optimised for the oxidation of carbon monoxide. Additionally, electrocatalysts for the electrochemical oxidation of carbon monoxide can be subject to corrosion, so it is simpler to provide membrane electrode assemblies containing only these electrocatalysts, and the membrane electrode assemblies can be replaced if the electrocatalysts corrode.

Suitably the anodes of the membrane electrode assemblies of the second group comprise an electrocatalyst for the electrochemical oxidation of hydrogen and preferably the electrocatalyst is Pt or is of formula Pt-M, wherein M is a metal alloyed with the platinum and is selected from the group consisting of Ru, Rh, Ti, Cr, Mn, Fe, Co, Ni, Cu, V, Ga, Zr and Hf.

In a preferred embodiment of the invention, the anodes of the membrane electrodes assemblies of the first group comprise only one electrocatalyst, and the electrocatalyst is of formula Pt—Y or Pt—Y—X, wherein Y is a bronze-forming element or oxide thereof or Y is Sn, and X is one or more metals alloyed with the platinum, and the anodes of the membrane electrode assemblies of the second group comprise only one electrocatalyst, and the electrocatalyst is of formula Pt-M, wherein M is a metal alloyed with the platinum and is selected from the group consisting of Ru, Rh, Ti, Cr, Mn, Fe, Co, Ni, Cu, V, Ga, Zr, Hf and Sn. In a most preferred embodiment of the invention, the anodes of the membrane electrodes assemblies of the first group comprise only one electrocatalyst, and the electrocatalyst is Pt—Mo, and the anodes of the membrane electrode assemblies of the second group comprise only one electrocatalyst, and the electrocatalyst is Pt—Ru.

In a particular embodiment of the invention the fuel cell stack(s) further comprise a third group of membrane electrode assemblies, wherein the second and third groups of membrane electrode assemblies are connected in series such that a feed stream supplied to the second group is subsequently supplied to the third group, and wherein the anodes of the membrane electrode assemblies of the second group comprise a first electrocatalyst for the electrochemical oxidation of hydrogen, and the anodes of the membrane electrode assemblies of the third group comprise a second electrocatalyst for the electrochemical oxidation of hydrogen, and the first electrocatalyst is more resistant to carbon monoxide poisoning than the second electrocatalyst.

The person skilled in the art can prepare membrane electrode assemblies for use as the first, second and optionally third groups of membrane electrode assemblies and can assemble them into one or more fuel cell stacks using well-known methods. The membrane electrode assemblies can be constructed by several methods. An electrocatalyst layer may be applied to a gas diffusion substrate to form a gas diffusion electrode. Two gas diffusion electrodes can be placed either side of a membrane and laminated together to form the five-layer MEA. Alternatively, electrocatalyst layers may be applied to both faces of a membrane to form a catalyst coated membrane (CCM). Subsequently, gas diffusion substrates are applied to both faces of the catalyst coated membrane. Finally, an MEA can be formed from a membrane coated on one side with an electrocatalyst layer, a gas diffusion substrate adjacent to that electrocatalyst layer, and a gas diffusion electrode on the other side of the membrane.

The membrane may be any type of proton-conducting membrane known to those skilled in the art. In state of the art membrane electrode assemblies, the membranes are often based on perfluorinated sulphonic acid materials such as Nafion® (DuPont), Flemion® (Asahi Glass) and Aciplex® (Asahi Kasei). The membrane may be a composite membrane, containing the proton-conducting material and other materials that confer properties such as mechanical strength. For example, the membrane may comprise a proton-conducting membrane and a matrix of silica fibres, as described in EP 875 524. The membrane is suitably less than 200 μm thick, preferably less than 50 μm thick.

The gas diffusion substrates may be any suitable gas diffusion substrates known to those skilled in the art. Typical substrates include substrates based on carbon paper (eg Toray® paper available from Toray Industries, Japan), woven carbon cloths (eg Zoltek® PWB-3 available from Zoltek Corporation, USA) or non-woven carbon fibre webs (eg Optimat 203 available from Technical Fibre Products, UK). The carbon substrate is typically modified with a particulate material either embedded within the substrate or coated onto the planar faces, or a combination of both. The particulate material is typically a mixture of carbon black and a polymer such as polytetrafluoroethylene (PTFE).

The electrocatalysts may be prepared using standard techniques such as those disclosed in WO 00/35037. The electrocatalysts may be finely divided metal powders (metal blacks), or may be supported catalysts wherein small metal particles are dispersed on electrically conducting particulate carbon supports. Preferably the electrocatalysts are supported catalysts. Standard techniques for forming electrocatalyst layers may be used, e.g. as disclosed in EP 731 520. The electrocatalyst layers suitably comprise ion-conducting material to improve the ionic conductivity of the electrocatalyst layers.

The membrane electrode assemblies can be assembled into fuel cell stacks using state-of-the-art field flow plates and stack assembly techniques. It may be preferable to use different field flow plates for the membrane electrode assemblies of the first and second groups, e.g. if it is intended to operate the membrane electrode assemblies of the first group at higher temperature or flow rates than the membrane electrode assemblies of the second group.

In a further aspect, the present invention provides a method of operating a fuel cell system according to the invention, comprising steps wherein:

a) a reformate gas stream comprising carbon monoxide is supplied to the first group of membrane electrode assemblies, thereby providing a gas stream with reduced carbon monoxide concentration; and

b) the gas stream with reduced carbon monoxide concentration is supplied to the second group of membrane electrode assemblies.

The reformate gas stream may be formed using standard reformer apparatus and is likely to comprise hydrogen, carbon dioxide, carbon monoxide and other impurities. The concentration of carbon monoxide is suitably from 10-20,000 ppm, preferably from 20-10,000 ppm. The method of the present invention can be carried out using higher concentrations of carbon monoxide than can typically be supplied to known fuel cell systems.

The first group of membrane electrode assemblies reduces the concentration of carbon monoxide in the reformate gas stream so that the gas stream supplied to the second group of membrane electrode assemblies has reduced carbon monoxide concentration. Preferably the concentration of carbon monoxide is reduced by 95%, preferably by 99%.

When operating a fuel cell system according to the invention, it may be preferable to operate the membrane electrode assemblies of the first group differently to the membrane electrode assemblies of the second group. For example, the first group of MEAs could be run at low current and high gas flow rate to minimise the consumption of hydrogen. Alternatively they could be run at higher temperature than the MEAs of the second group to enhance CO oxidation. The first and second group of MEAs can be controlled by a single control means.

For a more complete understanding of the invention, reference is made to the schematic drawings wherein:

FIG. 1 is a schematic diagram showing a fuel cell system according to a first embodiment of the invention.

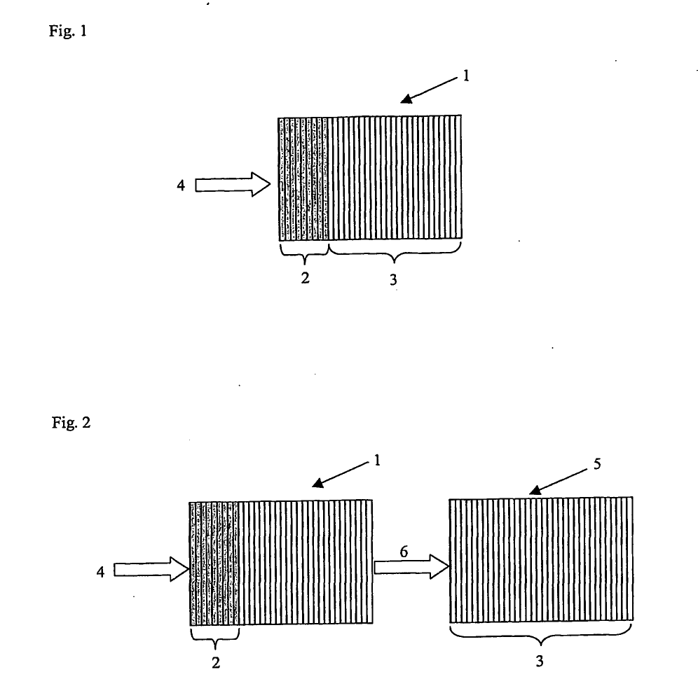

FIG. 2 is a schematic diagram showing a fuel cell system according to a second embodiment of the invention.

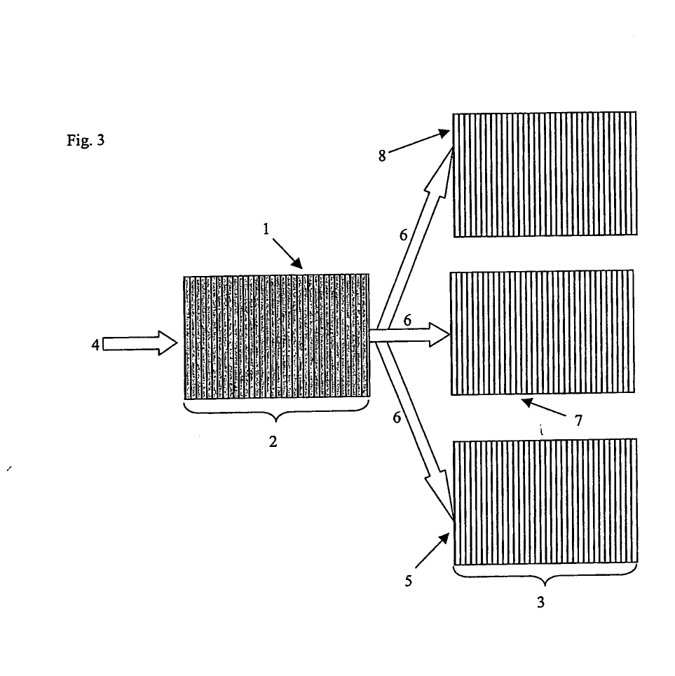

FIG. 3 is a schematic diagram showing a fuel cell system according to a third embodiment of the invention.

FIG. 1 shows a fuel cell stack (1) comprising a first group of membrane electrode assemblies (2) and a second group of membrane electrode assemblies (3). Reformate gas comprising carbon monoxide is supplied (4) to the first group of membrane electrode assemblies (2). Carbon monoxide is consumed by the first group of membrane electrode assemblies (2) so the gas supplied to the second group of membrane electrode assemblies (3) has reduced carbon monoxide concentration.

FIG. 2 shows a first fuel cell stack (1) comprising a first group of membrane electrode assemblies (2) and a second fuel cell stack (5) comprising a second group of membrane electrode assemblies (3). Reformate gas comprising carbon monoxide is supplied (4) to the first group of membrane electrode assemblies (2). Gas is supplied (6) from the first fuel cell stack (1) to the second fuel cell stack (5) and contains a reduced concentration of carbon monoxide so that the gas supplied to the second group of membrane electrode assemblies (3) has reduced carbon monoxide concentration.

FIG. 3 shows a first fuel cell stack (1) comprising a first group of membrane electrode assemblies (2), a second fuel cell stack (5) comprising a second group of membrane electrode assemblies (3), a third fuel cell stack (7) and a fourth fuel cell stack (8). All of the membrane electrode assemblies in the first fuel cell stack (1) provide the first group of membrane electrode assemblies (2). All of the membrane electrode assemblies in the second fuel cell stack (5) provide the second group of membrane electrode assemblies (3). Reformate gas comprising carbon monoxide is supplied (4) to the first group of membrane electrode assemblies (2). Gas is supplied (6) from the first fuel cell stack (1) to the second fuel cell stack (5), the third fuel cell stack (7) and the fourth fuel cell stack (8) and contains a reduced concentration of carbon monoxide so that the gas supplied to the second group of membrane electrode assemblies (3) has reduced carbon monoxide concentration.

1. A fuel cell system comprising at least one fuel cell stack,
wherein the at least one fuel cell stack comprises a first group of membrane electrode assemblies and a second group of membrane electrode assemblies,
wherein the first and second groups of membrane electrode assemblies are connected in series such that a feed stream supplied to the first group is subsequently supplied to the second group, and
wherein the anodes of the membrane electrode assemblies of the first group comprise an electrocatalyst for the electrochemical oxidation of carbon monoxide and are better at reducing the concentration of carbon monoxide in a feed stream comprising carbon monoxide than the membrane electrode assemblies of the second group.

2. A fuel cell system according to claim 1, wherein the at least one fuel cell stack comprises only one fuel cell stack, wherein some of the membrane electrode assemblies in the fuel cell stack provide the first group of membrane electrode assemblies, and some of the membrane electrode assemblies in the fuel cell stack provide the second group of membrane electrode assemblies.

3. A fuel cell system according to claim 1, wherein the at least one fuel cell stack comprises a first fuel cell stack and a second fuel cell stack, wherein the first and second fuel cell stacks are connected in series such that a feed stream supplied to the first fuel cell stack is subsequently supplied to the second fuel cell stack, and wherein some or all of the membrane electrode assemblies in the first fuel cell stack provide the first group of membrane electrode assemblies, and some or all of the membrane electrode assemblies in the second fuel cell stack provide the second group of membrane electrode assemblies.

4. A fuel cell system according to claim 3, wherein all of the membrane electrode assemblies in the first fuel cell stack provide the first group of membrane electrode assemblies, and all of the membrane electrode assemblies in the second fuel cell stack provide the second group of membrane electrode assemblies.

5. A fuel cell system according to claim 1, wherein the ratio of membrane electrode assemblies in the first group to membrane electrode assemblies in the second group is between 1:1 and 1:100.

6. A fuel cell system according to claim 1, wherein the electrocatalyst for the electrochemical oxidation of carbon monoxide is of formula Pt—Y or Pt—Y—X, wherein Y is a bronze-forming element or oxide thereof or is Sn, and X is one or more metals alloyed with the platinum.

7. A fuel cell system according to claim 6, wherein Y is selected from the group consisting of Sn, Ti, V, Ta, Mo, W and an oxide thereof.

8. A fuel cell system according to claim 6, wherein X is one or more metals selected from the group consisting of Ru, Rh, Ti, Cr, Mn, Fe, Co, Ni, Cu, V, Ga, Zr and Hf.

9. A fuel cell system according to claim 1, wherein the electrocatalyst for the electrochemical oxidation of carbon monoxide is Pt—Mo.

10. A fuel cell system according to claim 1, wherein the anodes of the membrane electrode assemblies of the first group further comprise an electrocatalyst for the electrochemical oxidation of hydrogen.

11. A fuel cell system according to claim 10, wherein the anodes of the membrane electrode assemblies of the first group comprise an electrocatalyst for the electrochemical oxidation of hydrogen and the electrocatalyst is of formula Pt-M, wherein M is a metal alloyed with the platinum and is selected from the group consisting of Ru, Rh, Ti, Cr, Mn, Fe, Co, Ni, Cu, V, Ga, Zr, Hf and Sn.

12. A fuel cell system according to claim 1, wherein the anodes of the membrane electrode assemblies of the first group do not contain any catalysts other than the catalyst for the oxidation of carbon monoxide.

13. A fuel cell system according to claim 1, wherein the anodes of the membrane electrode assemblies of the second group comprise an electrocatalyst for the electrochemical oxidation of hydrogen.

14. A fuel cell system according to claim 13, wherein the electrocatalyst is of formula Pt-M, wherein M is a metal alloyed with the platinum and is selected from the group consisting of Ru, Rh, Ti, Cr, Mn, Fe, Co, Ni, Cu, V, Ga, Zr and Hf.

15. A fuel cell system according to claim 1, wherein the anodes of the membrane electrodes assemblies of the first group comprise only one electrocatalyst, and the electrocatalyst is of formula Pt—Y or Pt—Y—X, wherein Y is a bronze-forming element or oxide thereof or Sn, and X is one or more metals alloyed with the platinum, and the anodes of the membrane electrode assemblies of the second group comprise only one electrocatalyst, and the electrocatalyst is of formula Pt-M, wherein M is a metal alloyed with the platinum and is selected from the group consisting of Ru, Rh, Ti, Cr, Mn, Fe, Co, Ni, Cu, V, Ga, Zr and Hf.

16. A fuel cell system according to claim 1, wherein the anodes of the membrane electrodes assemblies of the first group comprise only one electrocatalyst, and the electrocatalyst is Pt—Mo, and the anodes of the membrane electrode assemblies of the second group comprise only one electrocatalyst, and the electrocatalyst is Pt—Ru.

17. A fuel cell system according to claim 1, wherein the at least one fuel cell stack further comprises a third group of membrane electrode assemblies, wherein the second and third groups of membrane electrode assemblies are connected in series such that a feed stream supplied to the second group is subsequently supplied to the third group, and wherein the anodes of the membrane electrode assemblies of the second group comprise a first electrocatalyst for the electrochemical oxidation of hydrogen, and the anodes of the membrane electrode assemblies of the third group comprise a second electrocatalyst for the electrochemical oxidation of hydrogen, and the first electrocatalyst is more resistant to carbon monoxide poisoning than the second electrocatalyst.

18. A method of operating a fuel cell system according to claim 1, comprising the steps of:
a) supplying a reformate gas stream comprising carbon monoxide to the first group of membrane electrode assemblies, to provide a reformate gas stream with reduced carbon monoxide concentration; and
b) supplying the reformate gas stream with reduced carbon monoxide concentration to the second group of membrane electrode assemblies.

19. A method of operating a fuel cell system according to claim 18, wherein the reformate gas stream supplied to the first group of membrane electrode assemblies comprises from 10-20,000 ppm carbon monoxide.

20. A method of operating a fuel cell system according to claim 18, wherein the level of carbon monoxide in the reformate gas stream leaving the first group of membrane electrode assemblies has been reduced by at least 95%.

21. A fuel cell system according to claim 7, wherein X is one or more metals selected from the group consisting of Ru, Rh, Ti, Cr, Mn, Fe, Co, Ni, Cu, V, Ga, Zr and Hf.

22. A method of operating a fuel cell system according to claim 19, wherein the level of carbon monoxide in the reformate gas stream leaving the first group of membrane electrode assemblies has been reduced by at least 95%.
